(19) United States
(12) Patent Application Publication
(10) Pub. No.: US 2015/0121350 A1
(43) Pub. Date: Apr. 30, 2015

(54) VIRTUAL SIMULATION DEVICE AND VIRTUAL SIMULATION SYSTEM INCLUDING THE SAME, AND VIRTUAL SIMULATION METHOD

(71) Applicant: Kyungpook National University Industry-Academic Cooperation, Daegu (KR)

(72) Inventors: Woo Jin LEE, Suseong-gu (KR); Soo Young JANG, Yecheon-gun (KR)

(21) Appl. No.: 14/091,705

(22) Filed: Nov. 27, 2013

(30) Foreign Application Priority Data
Oct. 25, 2013 (KR) 10-2013-0127991

(51) Int. Cl. G06F 11/36

(52) U.S. Cl. CPC G06F 11/3664
USPC 717/135

(57) ABSTRACT

Provided is a virtual simulation device including a simulator unit executing embedded software; an image implementing unit implementing an image corresponding to an embedded system in which the embedded software is installed; and a state managing unit, wherein the state managing unit receives a state message created by executing the embedded software from the simulator unit, converts the state message into a control message capable of being interpreted by the image implementing unit and delivers the control message to the image implementing unit.

### CROSS-REFERENCE TO RELATED APPLICATIONS

This U.S. non-provisional patent application claims priority under 35 U.S.C. §119 of Korean Patent Application No. 10-2013-0127991, filed on Oct. 25, 2013, the entire contents of which are hereby incorporated by reference.

### BACKGROUND OF THE INVENTION

The present invention disclosed herein relates to a virtual simulation device and virtual simulation system including the same, and a virtual simulation method.

Embedded software that is loaded on various devices and executes products is not separately installed in a computer having an operating system (OS) but is embedded and used in an embedded system itself.

Currently, embedded software has been used to control hardware in various fields such as home appliances, air planes, and vehicles.

However, there is a drawback in that it is difficult to execute or verify embedded software without hardware where an actual program is executed, namely, an embedded system, even though the embedded software is developed. Such a drawback becomes a main factor that prolongs the development cycles of products in IT industry in which a consumption trend changes suddenly.

### SUMMARY OF THE INVENTION

The present invention provides a virtual simulation device and virtual simulation system including the same, and a virtual simulation method that may execute and test embedded software without an actual embedded system.

The present invention also provides a virtual simulation device and virtual simulation system including the same, and a virtual simulation method that may test embedded software more simply and efficiently without a lot of costs and a lot of efforts.

Embodiments of the present invention provide include virtual simulation devices including a simulator unit executing embedded software; an image implementing unit implementing an image corresponding to an embedded system in which the embedded software is installed; and a state managing unit, wherein the state managing unit receives a state message created by executing the embedded software from the simulator unit, converts the state message into a control message capable of being interpreted by the image implementing unit and delivers the control message to the image implementing unit.

In some embodiments, the image implementing unit may implement a shape of the embedded system as the image.

In other embodiments, the image implementing unit may implement the image as a shockwave flash (SWF) format.

In still other embodiments, the image implementing unit may implement the image so that at least one of components corresponding to controllable portions in the embedded system is included in the image.

In even other embodiments, the image implementing unit may implement the image so that the component has a plurality of states, and a component in each state may include at least one entity corresponding to a component shape of a corresponding state.

In yet other embodiments, the image implementing unit may change the state of the component according to the control message.

In further embodiments, the image implementing unit may create a manipulation message in response to image manipulation by a user, and the simulator unit may create the state message for changing the state of the component in response to the manipulation message.

In still further embodiments, the state managing unit may convert the state message into the control message with reference to a control table in which the state message is mapped to the control message.

In other embodiments of the present invention, virtual simulation systems include a display unit displaying an image corresponding to an embedded system; a user input unit receiving an input to manipulate the image from a user; a storage unit storing embedded software installed in the embedded system; and a processing unit executing the embedded software and changing the image, wherein the processing unit includes: a simulator unit executing the embedded software; an image implementing unit implementing the image and changing the image according to a control message; and a state managing unit, wherein the state managing unit receives a state message created by executing the embedded software from the simulator unit and converts the state message into a control message capable of being interpreted by the image implementing unit.

In still other embodiments of the present invention, virtual simulation methods include executing embedded software and creating a state message, by a simulator unit; converting, by a state managing unit, the state message into a control message capable of being interpreted by an image implementing unit; and changing, by the image implementing unit, an image corresponding to an embedded system according to the control message.

In some embodiments, the image may implement a shape of the embedded system.

In other embodiments, the image may be implemented as an SWF format.

In still other embodiments, the image may include at least one of components corresponding to controllable portions in the embedded system.

In even other embodiments, the component may have a plurality of states and a component in each state may include at least one entity corresponding to a component shape of a corresponding state.

In yet other embodiments, the changing of the image may include a component having a first state to a component having a second state according to the control message.

In further embodiments, the converting of the state message into the control message may include the state message into the control message with reference to a control table in which the state message is mapped to the control message.

In still further embodiments, the virtual simulation method may further include creating a manipulation message by the image implementing unit, in response to an input by a user who manipulates the image; and creating, by the simulator unit, the state message for changing the state of the component in response to the manipulation message.

In still other embodiments of the present invention, the virtual simulation method is implemented as a program capable of being executed on a computer and is recorded on a computer readable recording medium.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is an exemplary block diagram of a virtual simulation system according to an embodiment of the present invention;

FIG. 2 is an exemplary block diagram of a virtual simulation device according to an embodiment of the present invention;

FIG. 3 is a diagram for exemplarily explaining a configuration of an embedded system image according to an embodiment of the present invention;

FIG. 4 is a diagram for exemplarily explaining a configuration of a component according to an embodiment of the present invention;

FIG. 5 illustrates an image implementing a smart pharmacy unit as an embedded system according to an embodiment of the present invention;

FIGS. 6 and 7 illustrate processes of simulating the operations of an embedded system by using an image of a smart pharmacy unit according to an embodiment of the present invention; and

FIG. 8 is an exemplary flow chart of a virtual simulation method according to an embodiment of the present invention.

### DETAILED DESCRIPTION OF PREFERRED EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims.

When some terms are not defined, all the terms used herein (including technology or science terms) have the same meanings as those generally accepted by typical technologies in the related art to which the present invention pertains. The terms defined in general dictionaries may be construed as having the same meanings as those used in the disclosure and/or the related art and even when some terms are not clearly defined, they should not be construed as being conceptual or excessively formal.

The terms used herein are only for explaining specific embodiments while not limiting the present invention. The terms of a singular form may include plural forms unless referred to the contrary. The terms used herein “includes”, “comprises”, “including” and/or “comprising” do not exclude the presence or addition of one or more compositions, ingredients, components, steps, operations and/or elements other than the compositions, ingredients, components, steps, operations and/or elements that are mentioned.

In the disclosure, the term “and/or” indicates each of enumerated components or various combinations thereof.

On the other hand, the term “unit”, “group”, “block”, or “module” used herein may mean a unit for processing at least one function or operation. For example, it may means software or a hardware components such as FPGA or ASIC. However, the term “unit”, “group”, “block” or “module” is not limited to the software or the hardware. The term “unit”, “group”, “block” or “module” may be configured in an addressable storage medium or may be configured to operate one or more processors.

Thus, as an example, the “unit”, “group”, “block” or “module” includes components such as software components, object-oriented software components, class components, and task components, processes, functions, attributes, procedures, sub routines, program code segments, drivers, firmware, micro codes, circuits, data, DBs, data structures, tables, arrays and variables. The components and functions provided in the “unit”, “group”, “block” or “module” may be integrated as a smaller number of components and a smaller number of units, blocks, or modules or may be further divided into further components and further units, groups, or modules.

Various embodiments of the present invention are described below in more detail with reference to the accompanying drawings.

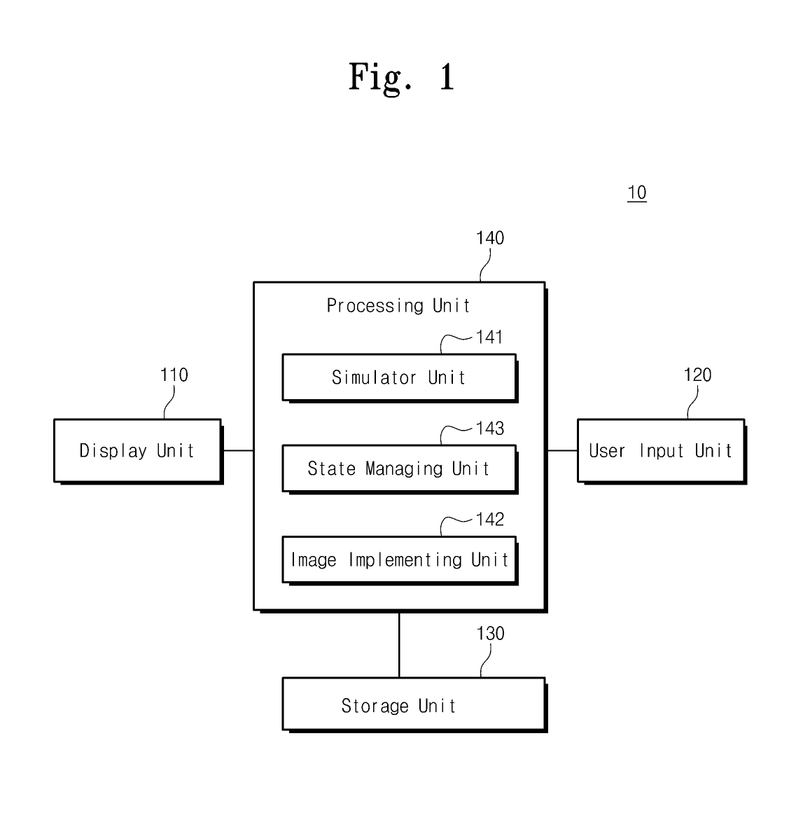

FIG. 1 is an exemplary block diagram of a virtual simulation system according to an embodiment of the present invention.

The virtual simulation system may implement an embedded system through an image, link embedded software to be embedded in the embedded system to the image implementing the embedded system, and simulate the operations of the embedded system and software.

To do this end, as shown in FIG. 1, a virtual simulation system 10 may include a display unit 110, a user input unit 120, a storage unit 130, and a processing unit 140.

The display unit 110 is a display device that visually displays an image corresponding to an embedded system, and may be an LCD display, for example. The user input unit 120 is an input device that receives an input to manipulate the image from a user, and may be a mouse, a keyboard, or a touch screen, for example. The storage unit 130 is a storage device that stores the embedded software installed in the embedded system, and may be a hard disk drive, a solid state drive, or a memory, for example. The processing unit 1410 is a processing device that executes the embedded software and changes the image, and may be a CPU or a GPU, for example.

As shown in FIG. 1, according to an embodiment of the present invention, the processing unit 140 may include a simulator unit 141, an image implementing unit 142, and a state managing unit 143.

The simulator unit 141 may execute the embedded software. The simulator unit 141 may call and execute the embedded software program stored in the storage unit 130 and create a message for operating the embedded system.

For example, the simulator unit 141 may execute the embedded software and create a state message that determines the state of the embedded system. An actual embedded system performs operations by using the current state determined by the state message but embodiments of the present invention converts the state message into a control message and changes an image that virtually implements the embedded system, as will be described below.

The image implementing unit 142 may implement an image corresponding to an embedded system. An image of the embedded system implemented by the image implementing unit 142 is displayed on the display unit 110 and visually provided to a user.

According to an embodiment, the image implementing unit 142 may implement the shape of an embedded system as an image. As an example, the image implementing unit 142 may implement the appearance of the embedded system as an image. As another example, the image implementing unit 142 may further reflect a state to the appearance of the embedded system and implement the embedded system as an image.

In particular, when the state of the embedded system is not visible, the image implementing unit 142 may visually implement a corresponding state and reflect it to an image. For example, when a speaker provided with the embedded system emits a sound or wind blows from a vent, the image implementing unit 142 may display notes or onomatopoeia around the speaker on the image of the embedded system or display a spin image of a pin wheel around the vent.

According to an embodiment, the image implementing unit 142 may implement the image of the embedded system in a shockwave flash (SWF) format.

The SWF format may simply and freely express various shapes of visual and auditory elements and easily process user's input events through an input device such as a keyboard or a mouse. An image produced in the SWF format may visualize the embedded system in linkage with the simulator unit 141, deliver user inputs input through the user input unit 120 to the simulator unit 141 and control the operations of the image of the embedded system.

The state managing unit 143 may receive a state message created by executing embedded software from the simulator unit 141, convert the state message into a control message that the image implementing unit 142 may interpret, and deliver the control message to the image implementing unit 142.

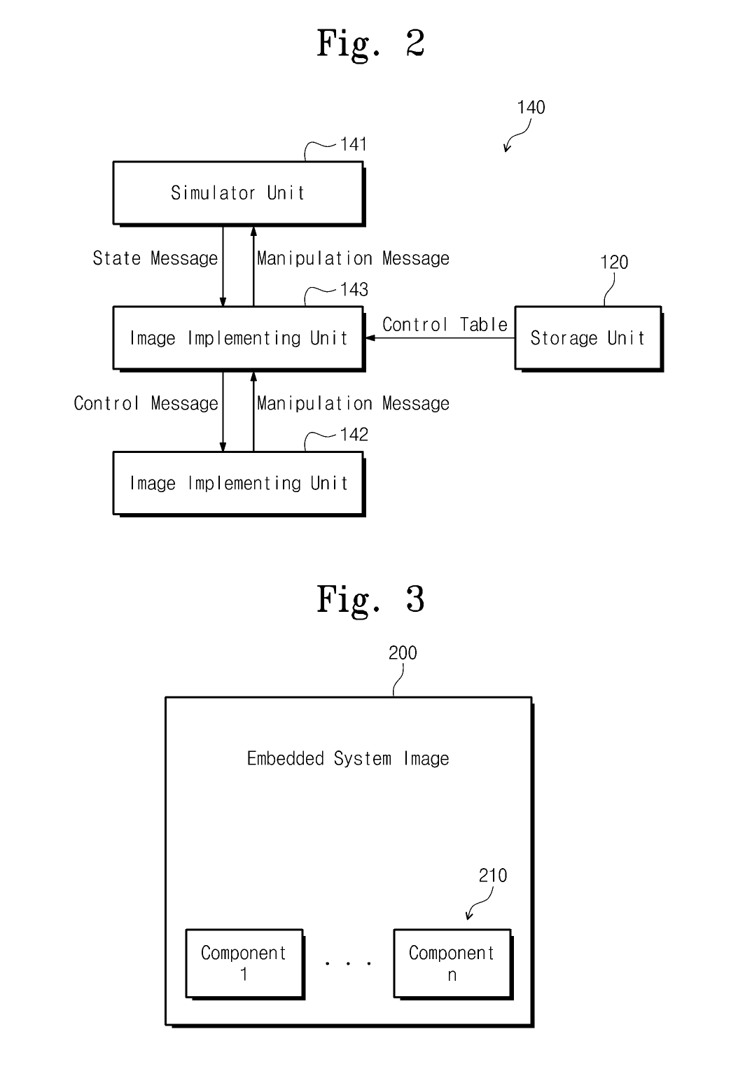

FIG. 2 is an exemplary block of a virtual simulation device 140 according to an embodiment of the present invention.

As shown in FIG. 2, the virtual simulation device 140 may include a simulator unit 141, an image implementing unit 142, and a state managing unit 143 and corresponds to the processing unit 140 as shown in FIG. 1.

The simulator unit 141 may execute embedded software and create a state message that determines the state of an embedded system. The state managing unit 143 may receive the state message, convert the state message into a control message with reference to a control table stored in a storage unit 120 and then deliver the control message to the image implementing unit 142.

The control table is a table in which the state message created by the embedded software is mapped to the control message described in the format that the image implementing unit 142 may interpret, and the control table may be stored in the storage unit 120 and read by the state managing unit 143.

The image implementing unit 142 may receive the control message from the state managing unit 143 and change the image of the embedded system according to the control message.

According to an embodiment of the present invention, a user may manipulate the image of the embedded system through the user input unit 120 and the image implementing unit 142 may create a manipulation message in response to the image manipulation by the user.

The simulator unit 141 may receive the manipulation message and then create a state message for changing the image of the embedded system in response thereto. The state message may be again converted into the control message by the state managing unit 143 as previously described and delivered to the image implementing unit 142, and the image implementing unit 142 may change the image of the embedded system based on the control message.

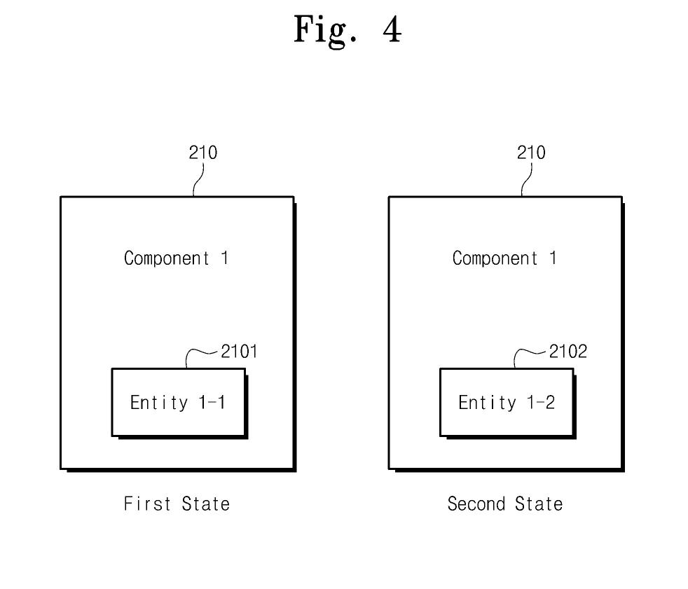

FIG. 3 is a diagram for exemplarily explaining a configuration of an embedded system image according to an embodiment of the present invention.

As shown in FIG. 3, the image implementing unit 142 may implement an embedded system as an image 200 and may be implemented so that at least one component 210 corresponding to a controllable portion in the embedded system is included in the image 200.

The components 210 are portions having different states in the embedded system and the states of the components 210 may be changed by user manipulation or the state message created by embedded software.

Thus, the image implementing unit 142 may implement images so that the components 210 have a plurality of states, and a component in each state may include at least one entity corresponding to the component shape of a corresponding state.

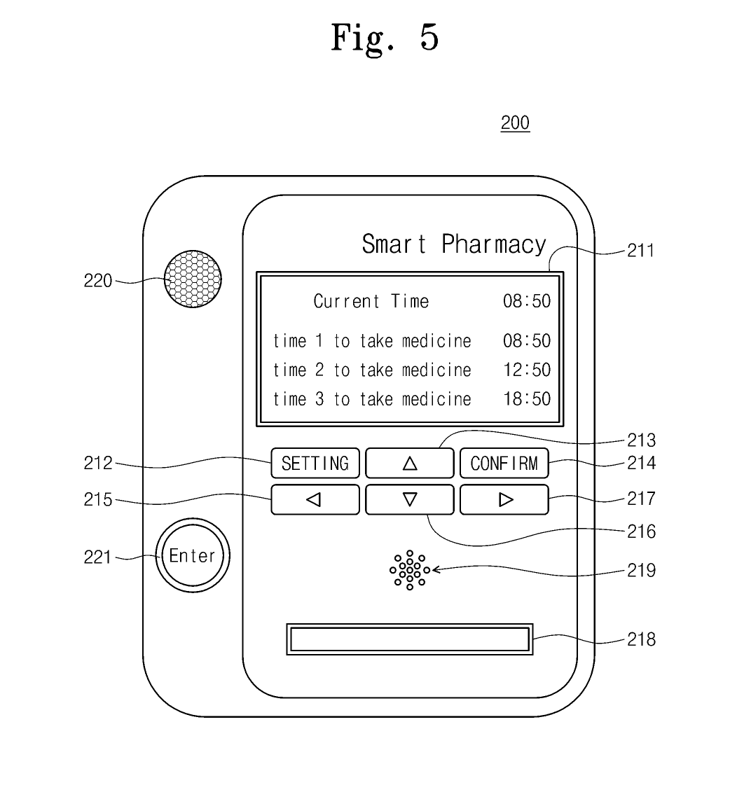

FIG. 4 is a diagram for exemplarily explaining a configuration of a component 210 according to an embodiment of the present invention.

As shown in FIG. 4, one component 210, for example, component 1 may have two or more states, for example, a first state and a second state. The component 210 in each state may be expressed by different entities.

For example, as shown in FIG. 4, the component 1 in the first state may include an entity 1-1 2101 but the component 1 in the second state may include an entity 1-2 2102. The entity 1-1 2101 and the entity 1-2 2102 implement, as images, different states of the same unit provided with the component and the image implementing unit 142 may be implemented so that according to the state of the component, a corresponding entity is included in the component.

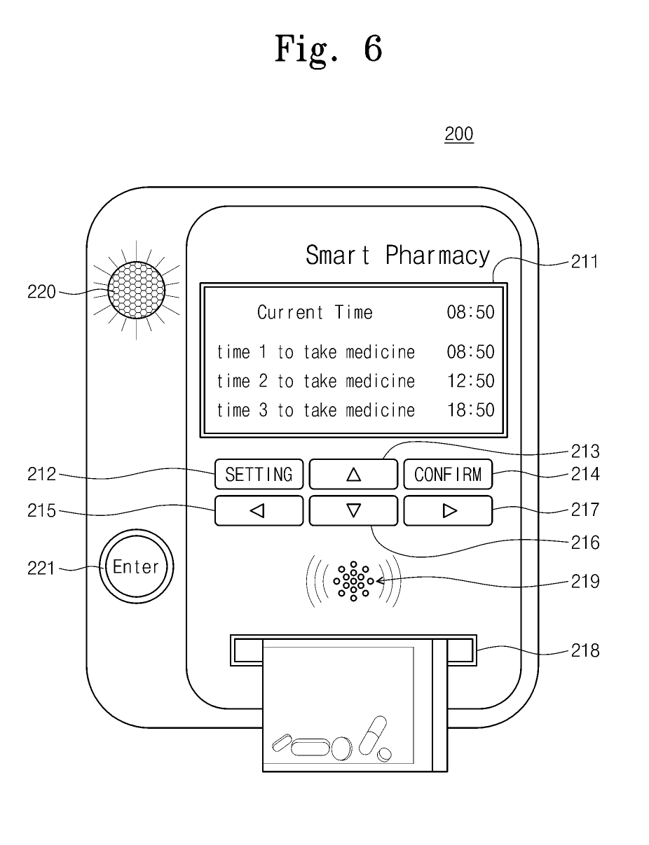

FIG. 5 illustrates an image 200 implementing a smart pharmacy unit as an embedded system according to an embodiment of the present invention.

As shown in FIG. 5, the image implementing unit 142 may implement the shape of the smart pharmacy unit, more particularly, the front surface thereof, as an image 200.

The image 200 of the smart pharmacy unit may include, as the components 210 corresponding to controllable portions, a display component 211, keypad components 212 to 217, a medicine dispenser component 218, a speaker component 219, a lamp component 220, and an enter key component 221.

The display component 211 may include number entities that represent the current time and medicine taking times, and each number entity may represent states corresponding to numbers 0 to 9.

Each the keypad components 212 to 217 and the enter key component 221 may include entities that represent a state when a key is not pressed and a state when the key is pressed. For example, the enter key component 221 may include two entities, an entity corresponding to a not-pressed enter key and an entity corresponding to a pressed enter key.

The medicine dispenser component 218 may include an entity representing an idle state that a medicine is not dispensed, an entity representing a state that the medicine is dispensed, and an entity representing a state that the medicine is separated form a dispenser.

The speaker component 219 may include an entity representing an idle state that a sound is not emitted, and an entity representing a state that the sound is being emitted.

The lamp component 220 may include an entity representing an idle state that a lamp is not turned on and an entity representing a state that the lamp is turned on.

As such, the image implementing unit 142 may implement images so that the image 200 corresponding to an embedded system includes at least one component 210 having a plurality of states, and the image 200 may be displayed on the display unit 110.

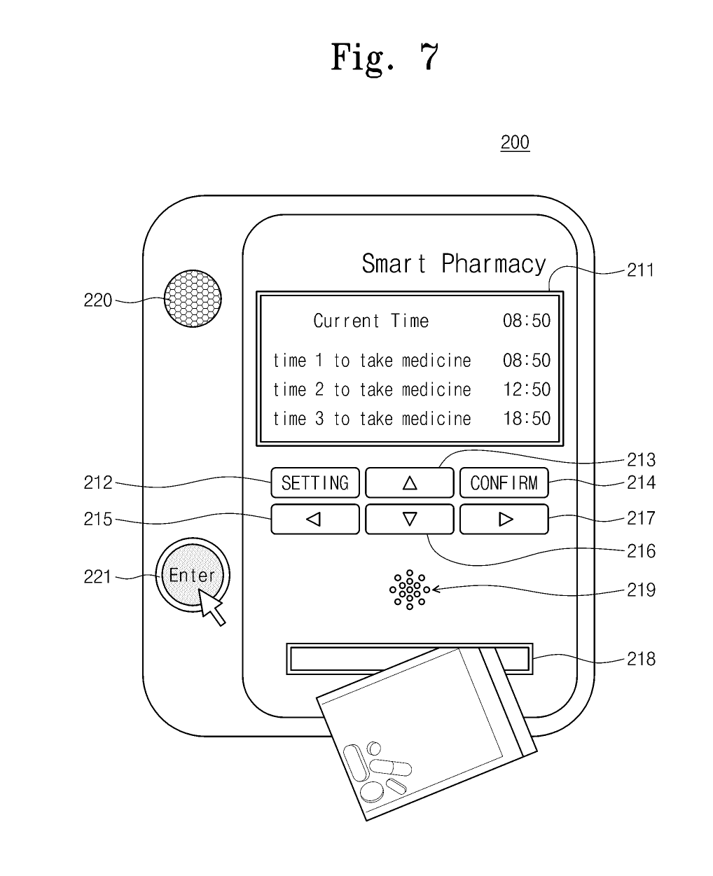

FIGS. 6 and 7 illustrate the processes of simulating the operations of an embedded system by using an image 200 of a smart pharmacy unit according to an embodiment of the present invention.

As previously described, the simulator unit 141 may execute the embedded system, namely, embedded software to be embedded in the smart pharmacy unit. As the embedded software is executed by the simulator unit 141, a state message that determines the state of the embedded system may be created.

For example, if the current time matches with any one of medicine taking times 1 to 3 as a result of executing the embedded software installed in the smart pharmacy unit, the simulator unit 141 may create a state message to dispense a medicine package including medicines from a medicine dispenser, a state message to emit beeps through a speaker, and a state message to turn on a lamp.

The state managing unit 143 may receive a state message from the simulator unit 141 and convert the state message into a control message that the image implementing unit 142 may interpret. In this case, the state managing unit 143 may convert a message with reference to a control table in which the state message is mapped to the control message. Then, according to the control message, the image implementing unit 142 may change an image 100, more particularly, the state of a component 210 included in the image. For example, as shown in FIG. 6, if a control message corresponding to a state message to dispense the medicine package from the medicine dispenser, the image implementing unit 142 may change the idle state entity of the medicine dispenser component 218 to the entity representing that the medicine has been dispensed. In addition, if a control message corresponding to a state message to emit beeps through a speaker is received, the image implementing unit 142 may change the idle state entity of a speaker component 219 to the entity representing that a sound is being emitted. In addition, if a control message corresponding to a state message to turn on a lamp is received, the image implementing unit 142 may change the idle state entity of a lamp component 220 to the entity representing that a lamp has been turned on.

According to an embodiment of the present invention, a user may manipulate the image 200 of the embedded system, and according to user manipulation, the image 200 of the embedded system may be changed.

As an example, a user may click keypad components 212 to 217 included in the image 200 to set medication taking times. As another example, if a medicine package is dispensed from the medicine dispenser component 218, the user may click an enter key component 221 to separate the medicine package from a medicine dispenser.

As such, if the user manipulates the image 200, the image implementing unit 142 may create a manipulation message in response to the image manipulation by the user, and the simulator unit 141 may create a state message for changing the state of a component 210 included in the image 200 and deliver the state message to a state managing unit 143.

For example, as shown in FIG. 7, if the user clicks the enter key component 221 after the medicine package is dispensed from the medicine dispenser component 218, the image implementing unit 142 may change an enter key entity having a not-pressed general state of the enter key component 221 to an enter key entity having a pressed state, display the enter key component on the image 200, create a manipulation message corresponding to the pressing of an enter key and deliver the manipulation message to the simulator unit 141.

Then, the simulator unit 141 may create a state message to determine that the medicine dispenser component 218 is in the state that the medicine package is separated, in response to the manipulation message corresponding to the pressing of the enter key.

The state managing unit 143 may convert the state message corresponding to the medicine package separated state into a control message that the image implementing unit 142 may interpret.

Then, as shown in FIG. 7, the image implementing unit 142 may change the entity of the medicine dispenser component 218 to an entity representing the medicine package separated state, according to the control message obtained through the conversion.

As such, the virtual simulation device 140 according to an embodiment of the present invention may change the image 200 of an embedded system through the interaction among the simulator unit 141, the image implementing unit 142, and the state managing unit 143, in response to an image manipulation input by a user.

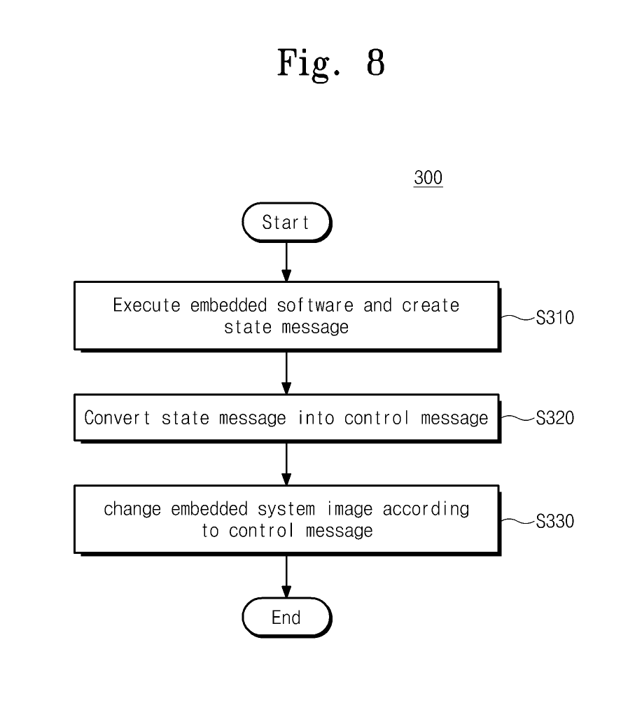

FIG. 8 is an exemplary flow chart of a virtual simulation method according to an embodiment of the present invention.

As shown in FIG. 8, a virtual simulation method 300 may include executing embedded software and creating a state message by a simulator unit 141 in step S310, converting, by a state managing unit 143, the state message into a control message capable of being interpreted by an image implementing unit 140 in step S320, and changing, by the image implementing unit 142, an image corresponding to an embedded system according to the control message in step S330.

According to an embodiment, the image corresponding to the embedded system may be obtained by implementing the shape of the embedded system. The image may be implemented as an SWF format.

According to an embodiment of the present invention, the image may include at least one component corresponding to controllable portions in the embedded system. The component may have two or more states and a component having each state may include at least one entity corresponding to the component shape of a corresponding state.

For example, as shown in FIGS. 5 to 7, the image 200 corresponding to a smart pharmacy unit may include a medicine dispenser component 218, which may include an entity (see FIG. 5) representing an idle state 218, an entity 218 (see FIG. 6) representing a state that the medicine has been dispensed, and an entity 218 (see FIG. 7) representing a state that a medicine package is cut. According to an embodiment, the converting of the state message into the control message in step S320 may include converting, by the state managing unit 143, the state message into the control message with reference to a control table in which the state message is mapped to the control message.

According to an embodiment, the changing of the image in step S330 may include changing a component having a first state to a component having a second state according to the control message, and the changing of the state of the component may include changing the current entity of the component to an entity corresponding to the control message.

According to an embodiment, the virtual simulation method 300 may further include creating, by the image implementing unit 142, a manipulation message in response to an input by a user who manipulates an image and creating, by the simulator unit 141, a state message for changing the state of the component in response to the manipulation message.

The virtual simulation method 300 according to the embodiment of the present invention may be produced as a program to be executed on a computer and may be stored in a computer readable recording medium. The computer readable recording medium includes all kinds of storage devices that store data capable of being read by a computer system. Examples of the computer readable recording medium may be a ROM, a RAM, a CD-ROM, a magnetic tape, a floppy disk, and an optical data storage device.

Although the present invention is described above through embodiments, the embodiments above are merely provided to describe the spirit of the present invention. A person skill in the art will understand that various modifications in the above-described embodiments may be made. The scope of the present invention is defined only by the following claims.

What is claimed is:

1. A virtual simulation device comprising:
a simulator unit executing embedded software;
an image implementing unit implementing an image corresponding to an embedded system in which the embedded software is installed; and
a state managing unit, wherein the state managing unit receives a state message created by executing the embedded software from the simulator unit, converts the state message into a control message capable of being interpreted by the image implementing unit and delivers the control message to the image implementing unit.

2. The virtual simulation device of claim 1, wherein the image implementing unit implements a shape of the embedded system as the image.

3. The virtual simulation device of claim 2, wherein the image implementing unit implements the image as a shockwave flash (SWF) format.

4. The virtual simulation device of claim 1, wherein the image implementing unit implements the image so that at least one of components corresponding to controllable portions in the embedded system is included in the image.

5. The virtual simulation device of claim 4, wherein the image implementing unit implements the image so that the component has a plurality of states, and
a component in each state comprise at least one entity corresponding to a component shape of a corresponding state.

6. The virtual simulation device of claim 5, wherein the image implementing unit changes the state of the component according to the control message.

7. The virtual simulation device of claim 5, wherein the image implementing unit creates a manipulation message in response to image manipulation by a user, and
the simulator unit creates the state message for changing the state of the component in response to the manipulation message.

8. The virtual simulation device of claim 1, wherein the state managing unit converts the state message into the control message with reference to a control table in which the state message is mapped to the control message.

9. A virtual simulation system comprising:
a display unit displaying an image corresponding to an embedded system;
a user input unit receiving an input to manipulate the image from a user;
a storage unit storing embedded software installed in the embedded system; and
a processing unit executing the embedded software and changing the image, wherein the processing unit comprises:
a simulator unit executing the embedded software;
an image implementing unit implementing the image and changing the image according to a control message; and
a state managing unit, wherein the state managing unit receives a state message created by executing the embedded software from the simulator unit and converts the state message into a control message capable of being interpreted by the image implementing unit.

10. A virtual simulation method comprising:
executing embedded software and creating a state message, by a simulator unit;
converting, by a state managing unit, the state message into a control message capable of being interpreted by an image implementing unit; and
changing, by the image implementing unit, an image corresponding to an embedded system according to the control message.

11. The virtual simulation method of claim 10, wherein the image implements a shape of the embedded system.

12. The virtual simulation method of claim 11, wherein the image is implemented as an SWF format.

13. The virtual simulation method of claim 10, wherein the image comprises at least one of components corresponding to controllable portions in the embedded system.

14. The virtual simulation method of claim 13, wherein the component has a plurality of states and a component in each state comprises at least one entity corresponding to a component shape of a corresponding state.

15. The virtual simulation method of claim 14, wherein the changing of the image comprises a component having a first state to a component having a second state according to the control message.

16. The virtual simulation method of claim 10, wherein the converting of the state message into the control message comprises the state message into the control message with reference to a control table in which the state message is mapped to the control message.

17. The virtual simulation method of claim 14, further comprising:
creating a manipulation message by the image implementing unit, in response to an input by a user who manipulates the image; and
creating, by the simulator unit, the state message for changing the state of the component in response to the manipulation message.

18. A computer readable recording medium on which a program to be executed on a computer is recorded, wherein the program implements the virtual simulation method according to claim 10.
